(19) United States
(12) Patent Application Publication
(10) Pub. No.: US 2010/0239329 A1
(43) Pub. Date: Sep. 23, 2010

(54) IMAGE FORMING APPARATUS

(75) Inventors: Hideyuki KITANI, Hino-shi (JP); Ryoichi Fujimoto, Toyohashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/726,914

(22) Filed: Mar. 18, 2010

(30) Foreign Application Priority Data
Mar. 19, 2009 (JP) 2009-067656

(51) Int. Cl. G03G 15/08

(52) U.S. Cl. 399/285

(57) ABSTRACT

An image forming apparatus includes a photoreceptor having a first support shaft supported in a first frame body, a photosensitive portion supported by the first support shaft, and a tapered portion having first tapered surfaces on both sides of the photosensitive portion; a development roller opposed to the photoreceptor and having a second support shaft rotatably supported by a second frame body, the development roller being movable in a direction perpendicular to the second support shaft so as to approach and separate from the photoreceptor; roller members disposed on both sides of the development roller coaxially with the second support shaft, the roller member being movable in an axial direction of the second support shaft and including a second tapered surface which abuts against the first tapered surface; a moving member allowing the roller member to move on the second support shaft; and a biasing member biasing the development roller toward the photoreceptor.

This application is based on application No. 2009-67656 filed in Japan on Mar. 19, 2009, the contents of which are hereby incorporated by reference.

### BACKGROUND OF THE INVENTION

The present invention relates to an electrophotographic image forming apparatus.

There is known an image forming apparatus in which a development roller is provided at its both ends with rollers (positioning rollers) that are coaxial with the development roller, the development roller is biased toward a photoreceptor, thereby constantly keeping a inter-surface distance Ds between a surface of the development roller and a surface of the photoreceptor.

Japanese Laid-open Patent Publication No. 8-30064 (Patent document 1) shows an image forming apparatus that employs the above configuration. In this image forming apparatus, since a value of the inter-surface distance Ds is determined by dimension accuracy of the roller and the development roller, if a standard of the inter-surface distance Ds becomes severe, accuracy required for each part also becomes severe, and the part becomes expensive. Since the photoreceptor and the development roller may be distorted, it becomes difficult to determine the inter-surface distance Ds only based on the accuracy of parts. There is a possibility that the inter-surface distance Ds is varied due to an abrasion between the roller and the photoreceptor depending upon a usage condition. In such a case, in order to correct the inter-surface distance Ds, there is a problem that the worn roller must be replaced by new one.

### SUMMARY OF THE INVENTION

It is an object of the present invention to provide an image forming apparatus that has a developing part for developing a latent image formed on a photoreceptor and that can easily and precisely adjust a inter-surface distance between the photoreceptor and a development roller with a simple structure.

An image forming apparatus of the present invention includes:

a photoreceptor having a first support shaft supported in a first frame body, a photosensitive portion supported by the first support shaft, and a tapered portion having first tapered surfaces on both sides of the photosensitive portion;

a development roller opposed to the photoreceptor and having a second support shaft rotatably supported by a second frame body, the development roller being movable in a direction perpendicular to the second support shaft so as to approach and separate from the photoreceptor;

roller members disposed on both sides of the development roller coaxially with the second support shaft, the roller member being movable in an axial direction of the second support shaft and including a second tapered surface which abuts against the first tapered surface;

a moving member allowing the roller member to move on the second support shaft; and

a biasing member biasing the development roller toward the photoreceptor.

Another image forming apparatus of the invention includes:

a photoreceptor having a first supporting shaft supported by a first frame body, the photoreceptor being movable in a direction of the first support shaft;

a development roller opposed to the photoreceptor and having a second support shaft rotatably supported in a second frame body, the development roller being movable in a direction perpendicular to the second support shaft so as to approach and separate from the photoreceptor;

a biasing member biasing the development roller toward the photoreceptor; and

an adjustment member movably mounted on any one of the first frame body and the second frame body such that the adjustment member is positioned between the first frame body and the second frame body, a portion of the adjustment member that abuts the other of the first frame body and the second frame body being an inclined surface with respect to a moving direction.

### BRIEF DESCRIPTION OF THE DRAWINGS

FIG. 1 is a schematic view showing one example of an entire structure of an image forming apparatus according to a first embodiment of the present invention;

FIG. 2 is a schematic side view of a portion of an image forming unit of the image forming apparatus according to the first embodiment of the invention;

FIG. 3A is an enlarged view of a photosensitive drum and a development roller of the image forming apparatus according to the first embodiment of the invention;

FIG. 3B is a partial sectional view showing that a bearing is threadedly engaged with a frame body of a toner cartridge in the image forming apparatus according to the first embodiment of the invention;

FIG. 4A is a view showing procedure of increasing a inter-surface distance Ds between the photosensitive drum and the development roller in the image forming apparatus according to the first embodiment of the invention;

FIG. 4B is a view showing procedure of reducing the inter-surface distance Ds between the photosensitive drum and the development roller in the image forming apparatus according to the first embodiment of the invention;

FIG. 5 is an enlarged view of a photosensitive drum and a development roller of an image forming apparatus according to a second embodiment of the invention; and

FIG. 6 is an enlarged view of a photosensitive drum and a development roller of an image forming apparatus according to a third embodiment of the invention.

### DETAILED DESCRIPTION OF THE PREFERRED EMBODIMENTS

Embodiments of the present invention will be described below with reference to the drawings.

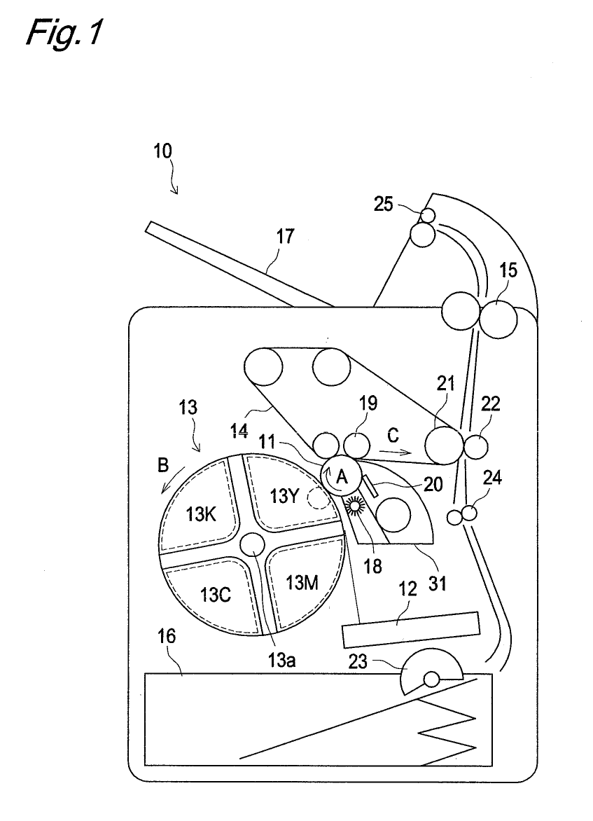

A structure and a summary of an image forming operation of one example of the image forming apparatus according to'a first embodiment of the present invention will be described with reference to FIG. 1. An image forming apparatus 10 is constituted as a full-color laser printer. The image forming apparatus 10 includes a photosensitive drum (photoreceptor) 11, a laser scanning optical device 12, a toner cartridge unit 13, an intermediate transfer belt 14, a fixing device 15, a sheet-feeding cassette 16, and an output tray 17 which are well known. A brush electrification device 18, the toner cartridge unit 13, a primary transfer roller 19, and a toner cleaning device 20 are disposed around the photosensitive drum 11.

The laser scanning optical device 12 is a known device provided therein with a laser diode as a light source, a polygon mirror as a deflection part, and fθ optical element. Printing data of each of colors including Y (yellow), M (magenta), C (cyan), and K (black) is sent from a host computer (not shown) to a controller of the laser scanning optical device 12. The laser scanning optical device 12 sequentially modulates laser beams based on the printing data of each color and carries out scanning and exposing operations on the photosensitive drum 11.

The photosensitive drum 11 is rotated in a direction of arrow A and is uniformly charged with predetermined surface potential by the brush electrification device 18 described below, and static latent images are sequentially formed by the scanning and exposing operations of laser beams of the laser scanning optical device 12.

The toner cartridge unit 13 is integrally provided with toner cartridges 13Y, 13M, 13C, and 13K having toner of colors Y, M, C, and K, respectively, and the toner cartridge unit 13 can rotate in a direction of arrow B around a spindle 13a. Whenever a static latent image corresponding to each color is formed on the photosensitive drum 11, the toner cartridge unit 13 is rotated such that one of the toner cartridges 13Y, 13M, 13C, and 13K having the corresponding color is located in a developing region so that the static latent image is developed with toner of a predetermined color.

Each of the toner cartridges 13Y, 13M, 13C, and 13K carries out a so-called reversal development by means of non-contact developing process using single-component non-magnetic toner. That is, toner is charged with the same polarity as the charged polarity of the photosensitive drum 11, and the toner adheres to an image portion where potential is reduced by exposure. The configuration and the developing operation of the toner cartridges 13Y, 13M, 13C, and 13K will be described in detail below.

The intermediate transfer belt 14 is attached in an endless manner on a roller group including the primary transfer roller 19 and a support roller 21 which are rotatable so that the intermediate transfer belt 14 can rotate in a direction of arrow C. Primary transfer voltage is applied to the primary transfer roller 19, so that a toner image formed on the photosensitive drum 11 is primary transferred onto the intermediate transfer belt 14. Toner images of respective colors are superposed on each other by this primary transfer so that a full-color image is formed.

A secondary transfer roller 22 is rotatably brought into contact under pressure with a portion of the intermediate transfer belt 14 that is supported by the support roller 21. When a paper sheet passes between the intermediate transfer belt 14 and the secondary transfer roller 22, secondary transfer voltage is applied to the secondary transfer roller 22, so that a full-color toner image is secondary transferred onto the paper sheet.

Paper sheets are sent out from the sheet-feeding cassette 16 by a sheet-feeding roller 23 one by one, and the paper sheets are conveyed to a secondary transfer position in synchronization with a toner image on the intermediate transfer belt 14 by a timing roller 24.

The toner image that was secondary transferred onto the paper sheet is heated and fixed by the fixing device 15, and the paper sheet is discharged onto the output tray 17 by an output roller 25.

The full-color image forming apparatuses have various basic types, and the laser printer shown in FIG. 1 is a four-cycle type in which the four toner cartridges 13Y, 13M, 13C, and 13K are disposed around the one photosensitive drum 11. The image forming apparatus according to the present invention may not be of the four-cycle type, and other types such as a tandem type in which four photosensitive drums are arranged along an intermediate transfer belt may be employed.

The present invention is not limited to the full-color laser printer and the invention can also be applied to a monochrome image forming apparatus. The invention can also be applied to any of a single-component development in which a developer including toner only is used and a two-component development in which a mixture of toner and a carrier is used.

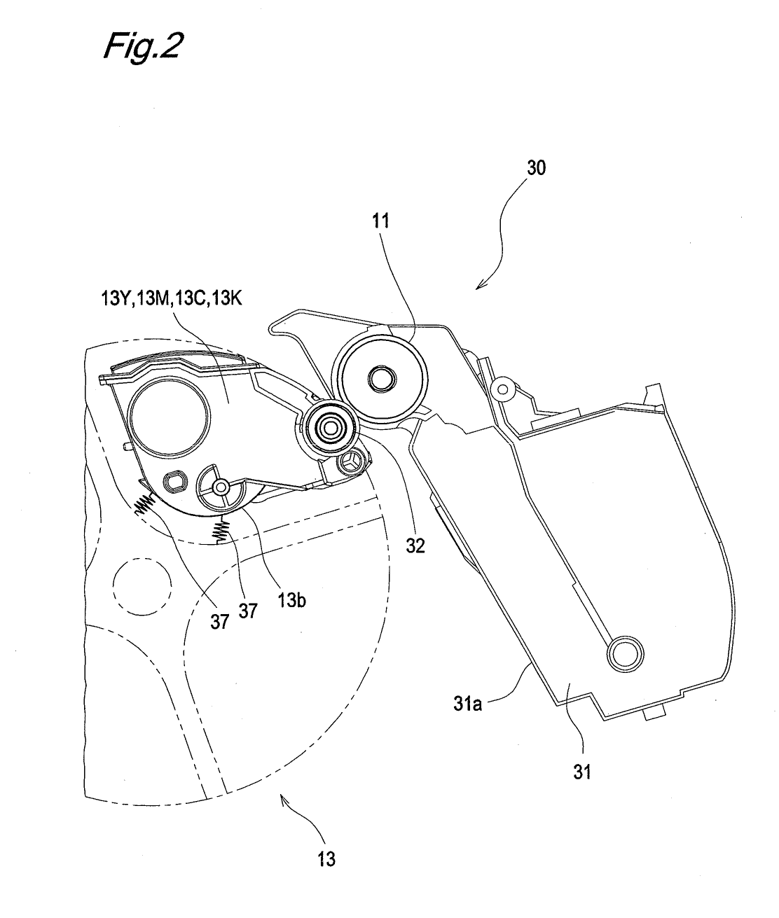

FIG. 2 is a schematic side view of an image forming unit 30 of the image forming apparatus 10 of the embodiment.

The image forming unit 30 includes a drum cartridge unit 31 having the photosensitive drum 11, and the toner cartridge unit 13 in which the four toner cartridges 13Y, 13M, 13C, and 13K are accommodated at predetermined distances from one another in its circumferential direction. For brevity, FIG. 2 shows only the drum cartridge unit 31 and one of the four toner cartridges 13Y, 13M, 13C, and 13K, but a multifunction printer of this embodiment can color print in the four-cycle type using four kinds of toner including cyan, magenta, yellow, and black.

The drum cartridge unit 31 is detachably attached to a rack provided in a casing of the image forming apparatus 10. The drum cartridge unit 31 is provided therein with at least the photosensitive drum 11 as a photoreceptor and the brush electrification device 18 as a charging part.

A development roller 32 as developer-carrier, a layer-thickness limiting blade (not shown), a supply roller (not shown) and toner as the developer are accommodated in each of the toner cartridges 13Y, 13M, 13C, and 13K.

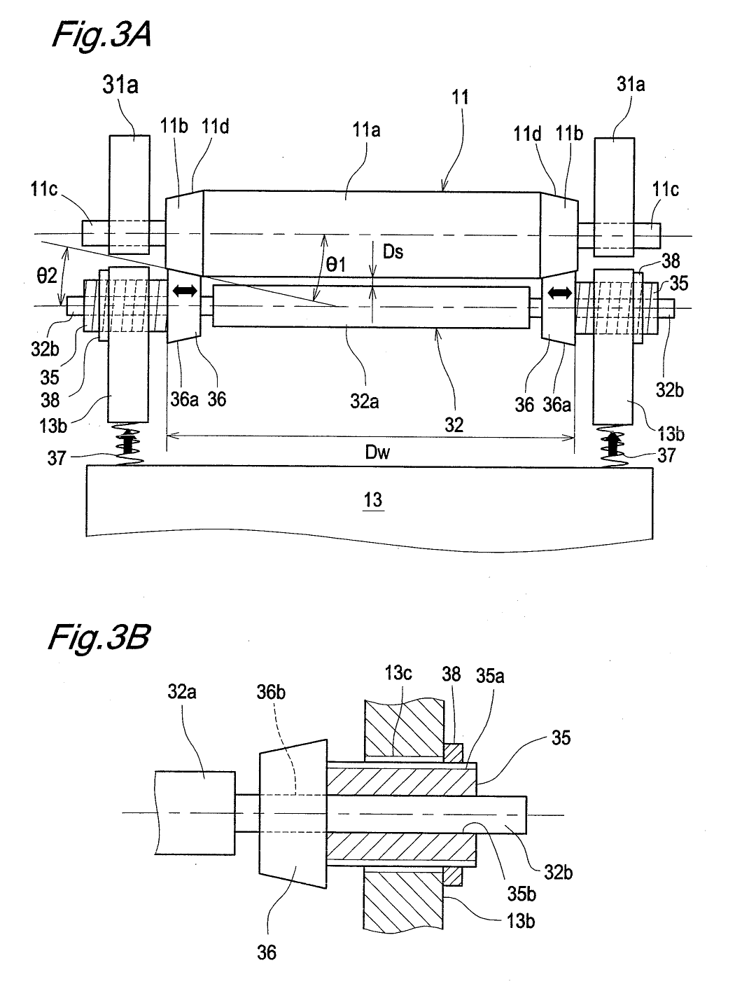

FIG. 3A is an enlarged view of the photosensitive drum 11 and the development roller 32. The photosensitive drum 11 includes a photosensitive portion 11a, tapered portions 11b and support shafts (first support shafts) 11c. The photosensitive portion 11a is of columnar shape. The tapered portions 11b are continuously formed on both sides of the photosensitive portion 11a, and respectively include first tapered surfaces 11d. Each of the first tapered surfaces 11d is a circular conical surface extending in a tapered manner from the photosensitive portion 11a toward an end surface thereof in an axial direction of the first support shaft 11c. Each of the support shafts 11c projects outward of the tapered portion 11b coaxially with a center axis of rotation of the photosensitive portion 11a. A taper angle θ1 formed between the center axis of the support shaft 11c and an outline formed by the first tapered surface 11d of the tapered portion 11b is an acute angle (0<θ1 <90° when viewing the photosensitive drum 11 from one direction that is perpendicular to the center axis of rotation of the photosensitive drum 11. The support shaft 11c of the photosensitive drum 11 is rotatably supported by a frame body (first frame body) 31a of the drum cartridge unit 31.

The development roller 32 includes a developing portion 32a and support shafts (second support shafts) 32b. The developing portion 32a is of columnar shape. Each of the support shafts 32b projects outward coaxially with a center axis of rotation of the developing portion 32a.

The support shafts 32b of the development roller 32 are rotatably supported by frame bodies (second frame bodies) 13b of the toner cartridges 13Y, 13M, 13C, and 13K through later-described bearings 35. In this embodiment, the bearings 35 constitutes moving members of the present invention.

As shown in FIG. 3B, each bearing 35 is of a cylindrical shape. A through hole 35b having a size capable of slidably supporting the support shaft 32b of the development roller 32 is formed in an inner peripheral surface (inner race). A second screw portion 35a is provided on an outer peripheral surface (outer race) of the bearing 35. Each bearing 35 is supported by the frame bodies 13b of the toner cartridges 13Y, 13M, 13C, and 13K by threadedly engaging the second screw portion 35a of the outer peripheral surface and the first screw portion 13c provided in the frame body 13b of the toner cartridges 13Y, 13M, 13C, and 13K with each other. The frame bodies 13b of the toner cartridges 13Y, 13M, 13C, and 13K support the bearings 35 in a state where the support shafts 32b of the development roller 32 are inserted. The second screw portion 35a is formed with a male thread. The first screw portion 13c is formed with a female thread. A nut 38 is threadedly engaged with each support shaft 32b on a tip end side of the support shaft 32b of the frame body 13b for preventing the second screw portion 35a of the bearing 35 from rotating with respect to the first screw portion 13c of the frame body 13b of each of the toner cartridges 13Y, 13M, 13C, and 13K. The nut 38 exhibits a function as a so-called double nut together with the frame body 13b of the first screw portion 13c.

Roller members 36 each having a through hole 36b is disposed on the support shafts 32b on both sides of the developing portion 32a. Each roller member 36 is located between the developing portion 32a and the bearing 35, and is coaxial with the support shaft 32b of the development roller 32. The roller member 36 is inserted such that it can move in the axial direction of the support shaft 32b. Each roller member 36 is provided with a second tapered surface 36a. A taper angle θ2 formed between the center axis of rotation of the support shaft 32b and an outline formed by the second tapered surface 36a of the roller member 36 is an acute angle (0<θ2<90° when viewing the roller member 36 from one direction that is perpendicular to the center axis of rotation of the development roller 32. The taper angle θ2 of the second tapered surface 36a of the roller member 36 is the same as the taper angle θ1 of the tapered portion 11b of the photosensitive drum 11. A ridgeline of the second tapered surface 36a and a ridgeline of the first tapered surface 11d abut against each other. The roller member 36 is made of material having such strength that the roller member 36 is not elastically deformed. Since the roller member 36 is required to have follower performance, material having high coefficient of static friction is preferable. Examples of the preferable materials are POM (polyoxymethylene (polyacetal)) and PC (polycarbonate) which are known as Delrin® (registered trademark) and Duracon The roller member 36 may be made of other material such as metal.

The toner cartridge unit 13 is provided with a plurality of springs (biasing member) 37 that are connected to the frame bodies 13b of the toner cartridges 13Y, 13M, 13C, and 13K. The toner cartridges 13Y, 13M, 13C, and 13K are biased radially outward from the toner cartridge unit 13. The springs 37 have the same spring constants so that the springs can bias the development rollers 32 of the toner cartridges 13Y, 13M, 13C, and 13K toward the photosensitive drum 11 with the same forces through both the support shafts 32b of the development rollers 32. The development roller 32 can also reliably be biased toward the photosensitive drum 11 through the roller member 36 into which the support shaft 32b is inserted by means of the plurality of springs 37 in a direction perpendicular to a line connecting, with each other, the springs which bias both the support shafts 32b of the development roller 32.

If a static latent image corresponding to each color is formed on the photosensitive drum 11, the toner cartridge unit 13 rotates, one of the toner cartridges 13Y, 13M, 13C, and 13K that has toner of the corresponding color is disposed in the development region. In this position, the toner cartridges 13Y, 13M, 13C, and 13K are biased by the springs 37 radially outward, and the first tapered surface 11d of the tapered portion 11b of the photosensitive drum 11 and the second tapered surface 36a of the roller member 36 abut against each other. The photosensitive drum 11 and the development roller 32 are opposed to each other.

When the development roller 32 is driven, a force is applied to the tapered portion 11b of the photosensitive drum 11 from the second tapered surface 36a of the roller member 36 biased by the springs 37 through the toner cartridges 13Y, 13M, 13C, and 13K. A reaction force from the first tapered surface 11d of the tapered portion 11b of the photosensitive drum 11 against this force is applied in a direction perpendicular to the second tapered surface 36a of the roller member 36. The roller member 36 is biased toward the support shaft 32b in a direction separating away from an end surface of the developing portion 32a by a component of the reaction force toward the support shaft 32b. As a result, the roller member 36 abuts against the bearing 35. The first tapered surface 11d of the tapered portion 11b of the photosensitive drum 11 and the second tapered surface 36a of the roller member 36 also abut against each other. By these abutment states, the inter-surface distance Ds between the photosensitive drum 11 and the development roller 32 is maintained constant.

Next, an adjusting method of the inter-surface distance Ds between the photosensitive drum 11 and the development roller 32 in the image forming apparatus 10 according to the invention will be described.

The inter-surface distance Ds between the photosensitive drum 11 and the development roller 32 is determined by a relative positional relation between the tapered portion 11b of the photosensitive drum 11 and the roller member 36 in the direction of the support shaft 32b.

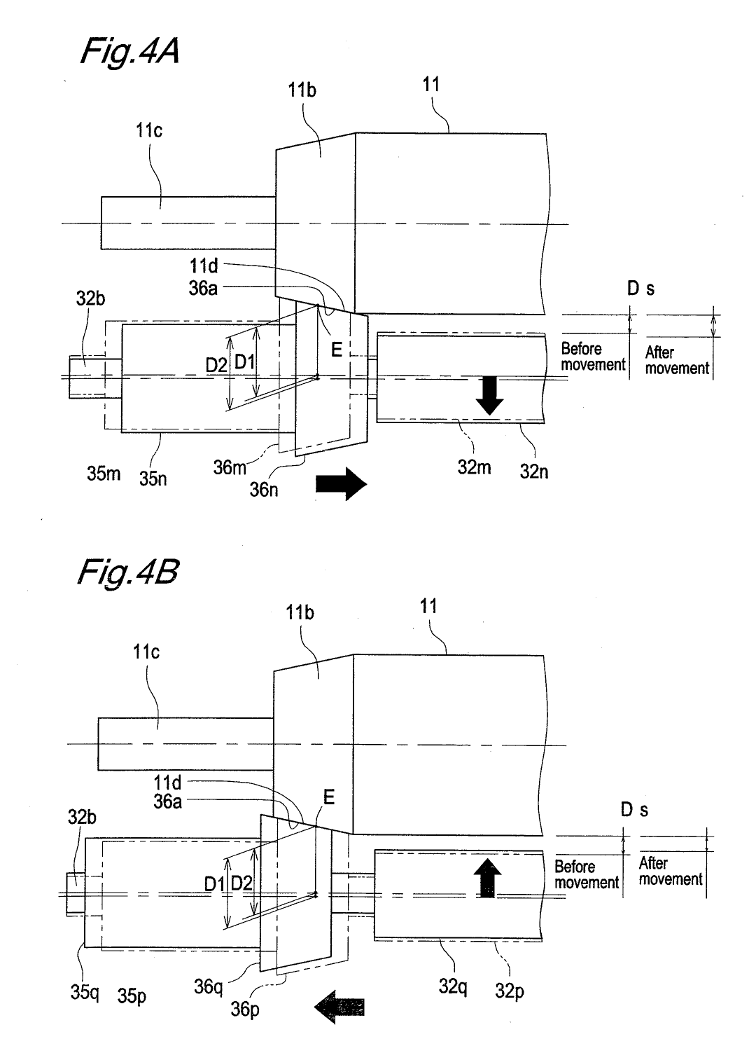

As shown in FIGS. 4a and 4b, the first tapered surface 11d of the tapered portion 11b of the photosensitive drum 11 and the second tapered surface 36a of the roller member 36 are in abutment with each other. Therefore, if a distance between a point E on the abutment line and a point on an axial center of the support shaft 32b in a direction perpendicular to the support shaft 32b is defined as D1, the distance D1 from the point E to the point on the support shaft 32b is changed to a distance D2 when the roller member 36 is moved forward and backward on the support shaft 32b by rotating the bearing 35. When the roller member 36 approaches the development roller 32, the distance D2 becomes greater than the distance D1 (D1<D2), and when the roller member 36 separates from the development roller 32, the distance D2 becomes smaller than the distance D1 (D1>D2).

More specifically, as shown in FIG. 4A, if a bearing 35m is rotated and a roller member 36m is moved to a position of a roller member 36n that approaches a development roller 32m, the development roller 32m moves in a direction separating away from the photosensitive drum 11 toward the position of the development roller 32n. As a result, the inter-surface distance Ds becomes longer. On the contrary, if a bearing 35p is reversely rotated to move a roller member 36p to a position of a roller member 36q that is separated away from a development roller 32p as shown in FIG. 4B, the development roller 32p moves in a direction approaching the photosensitive drum 11 toward the position of the development roller 32q. As a result, the inter-surface distance Ds becomes shorter. In this manner, it is possible to move the development roller 32 toward or away from the photosensitive drum 11 in the direction perpendicular to the support shaft 32b of the development roller 32.

In a concrete method of adjusting the inter-surface distance Ds between the photosensitive drum 11 and the development roller 32, the inter-surface distance Ds is first measured. As measuring methods of the inter-surface distance Ds, there are a method of measuring the distance by a measuring device (such as laser) and a method of measuring the distance by a thickness gauge.

If a measured value is obtained, a difference between the measured value and a desired inter-surface distance Ds value is obtained. Then, the nut 38 is loosened and both the bearings 35 are moved by an amount corresponding to the difference in opposite directions using the screw pitch of the second screw portion 35a to adjust a distance Dw between abutment surfaces at which the roller members 36 and the bearings 35 on both sides of the developing portion 32a abut against each other. A variation amount Y of the inter-surface distance Ds is determined by a moving amount X of the bearing 35, i.e., of the roller member 36, and the angle θ2 of the second tapered surface 36a of the roller member 36. With respect to the moving amount (adjusting amount) X of the roller member 36 on the support shaft 32b, a variation amount Y of the inter-surface distance Ds is Y=X tan θ2. After the distance Dw is adjusted, the bearings 35 are fixed by the nuts 38 to prevent the bearings 35 from rotating when the development roller 32 is driven.

With the above procedure, it is possible to easily and precisely adjust the inter-surface distance Ds between the photoreceptor 11 and the development roller 32 without relying on the accuracy of the photoreceptor 11 and the development roller 32 and accuracy of parts interposed therebetween. Even after the development roller 32 is once attached to the photoreceptor 11, the inter-surface distance Ds can be adjusted by moving the roller member 36 having the second tapered surface 36a. That is, even if the roller member 36 is used over the long term and it is worn and the inter-surface distance Ds is varied, the inter-surface distance Ds can be corrected by moving the roller member 36.

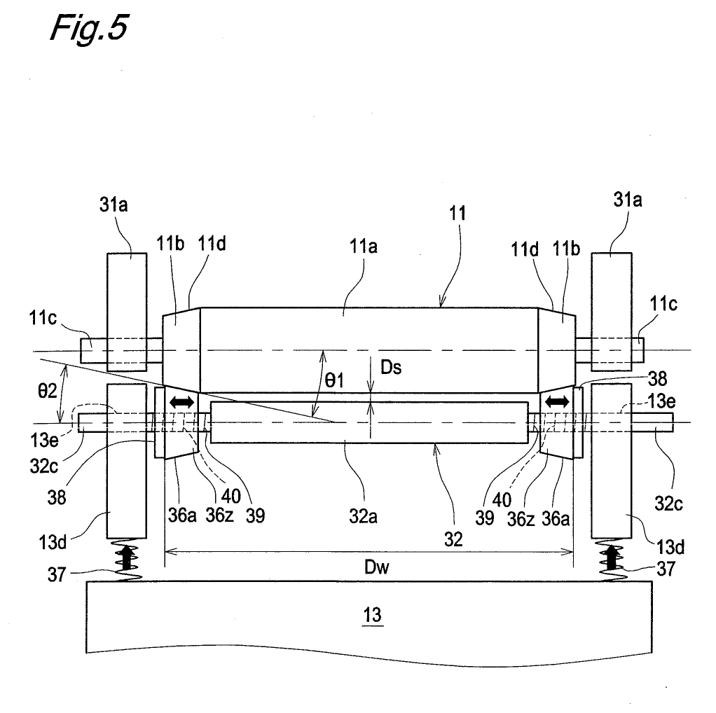

FIG. 5 is an enlarged view of a photosensitive drum 11 and a development roller 32 of an image forming apparatus according to a second embodiment of the invention. In the second embodiment, the same constituent elements as those of the first embodiment are designated with the same symbols, and explanation thereof will be omitted.

In the second embodiment, the development roller 32 includes a developing portion 32a and support shafts (second support shafts) 32c. Each of the support shafts 32c projects outward coaxially with a center axis of rotation of the developing portion 32a. The support shaft 32c is provided with third screw portions 39. Each of the third screw portions 39 has such a length that a roller member 36z is inserted from a connected portion between the developing portion 32a and the support shaft 32c and the nut 38 is fastened and the inter-surface distance Ds can be adjusted, and it is unnecessary that the third screw portion 39 is provided over the entire support shaft 32c. The third screw portion 39 is formed with a male thread.

Fourth screw portions 40 that threadedly engage with the third screw portions 39 are provided on surfaces of the roller members 36z where the through holes 36b of the roller member 36 of the first embodiment are formed. Each of the fourth screw portions 40 is formed with a female thread. In this embodiment, the roller members 36z themselves are moving members.

Since the third screw portions 39 of the support shafts 32c of the development roller 32 and the fourth screw portions 40 of the roller members 36z are threadedly engaged with each other, it is unnecessary to provide the bearings 35, but in order to prevent the roller members 36z from rotating when the development roller 32 is driven, the roller members 36z are fixed by means of the nuts 38. In this case also, they are fixed as double nuts by the roller members 36z having the fourth screw portions 40 and the nuts 38.

Through holes 13e are formed in the frame bodies (second frame bodies) 13d of the toner cartridges 13Y, 13M, 13C, and 13K. Each through hole 13d has such a size that the support shaft 32c can slide therein. The support shaft 32c of the development roller 32 is inserted into the through hole 13e and supported by the frame bodies 13d of the toner cartridges 13Y, 13M, 13C, and 13K.

A concrete adjusting method of the inter-surface distance Ds between the photosensitive drum 11 and the development roller 32 in this embodiment is performed by adjusting the distance Dw between a surface of one of the roller members 36z that is in contact with one of the nuts 38 and a surface of the other roller member 36z that is in contact with the other nut 38 in the same manner as the first embodiment. however, the roller members 36z are not moved through the bearings 35 unlike the first embodiment, and the roller members 36z are moved in the opposite directions by the same amount utilizing a screw pitch of the roller member 36z itself. It is necessary that the adjustment in the second embodiment is performed by releasing the abutment between the photosensitive drum 11 and the development roller 32 due to configuration of the second embodiment. After the distance Dw is adjusted, the roller members 36z are fixed by the nuts 38 to prevent the roller members 36z from rotating when the development roller 32 is driven.

With the above procedure, it is possible to easily and precisely adjust the inter-surface distance Ds between the photoreceptor 11 and the development roller 32 without relying on the accuracy of the photoreceptor 11 and the development roller 32 and accuracy of parts interposed therebetween. Even after the development roller 32 is once attached to the photoreceptor 11, the inter-surface distance Ds can be adjusted by moving the roller member 36z having the second tapered surface 36a. That is, even if the roller member 36z is used over the long term and it is worn and the inter-surface distance Ds is varied, the inter-surface distance Ds can be corrected by moving the roller member 36z.

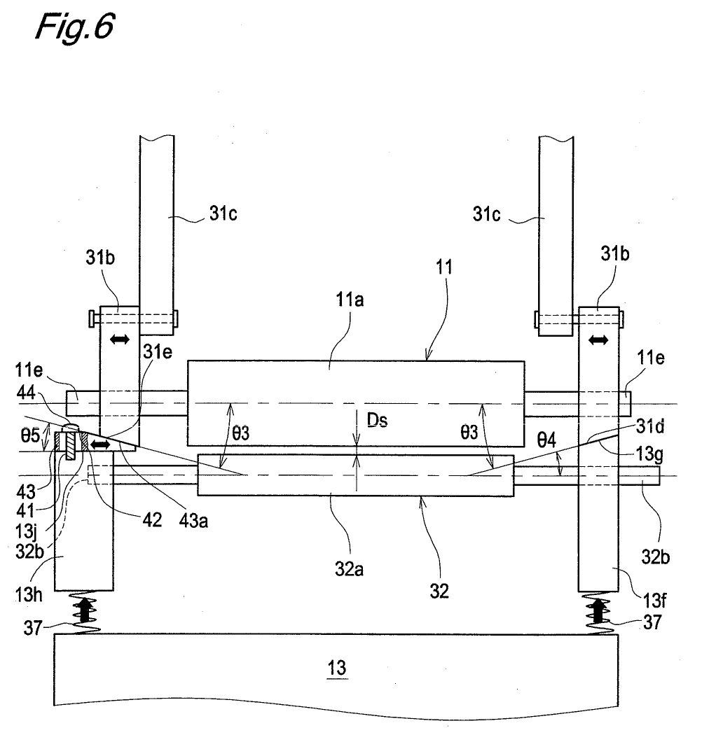

FIG. 6 is an enlarged view of a photosensitive drum 11 and a development roller 32 of an image forming apparatus according to a third embodiment of the invention. In the third embodiment, the same constituent elements as those of the first embodiment are designated with the same symbols, and explanation thereof will be omitted.

In the third embodiment, the photosensitive drum 11 includes a photosensitive portion 11a and support shafts (first support shafts) 11e. The photosensitive portion 11a is of a columnar shape. Each of the support shafts 11e projects outward of the photosensitive portion 11a coaxially with a center axis of rotation of the photosensitive portion 11a. The photoreceptor support portion 31b can slightly move in the axial direction of the support shaft 11e of the photosensitive drum 11, and is connected such that the photoreceptor support portion 31b becomes a portion of the frame body (first frame body) 31c of the drum cartridge unit 31. The support shafts 11e of the photosensitive drum 11 are supported by the photoreceptor support portions 31b of the drum cartridge unit 31.

A taper angle θ3 formed between the center axis of the support shaft 11e and an outline formed by an end surface 31d or an end surface 31e of the photoreceptor support portion 31b is an acute angle (0<θ3<90° when the end surface 31d and the end surface 31e of the photoreceptor support portions 31b located on both sides of the photosensitive portion 11a on the side of the toner cartridges 13Y, 13M, 13C, and 13K are viewed edge-on.

A taper angle θ4 formed between the center axis of the support shaft 32b and an outline formed by an end surface 13g of the frame body 13f is an acute angle (0<θ4 <90° when the end surface 13g of the frame bodies (second frame bodies) 13f of the toner cartridges 13Y, 13M, 13C, and 13K are viewed edge-on. The taper angle θ4 is the same as the taper angle θ3 of the end surface 31d of the photoreceptor support portion 31b.

End surfaces 13j of the frame bodies (second frame bodies) 13h of the toner cartridges 13Y, 13M, 13C, and 13K on the side of the drum cartridge unit 31 are surfaces which are perpendicular to a direction in which the development roller 32 is biased toward the photosensitive drum 11 unlike the end surfaces 13g, 31d, and 31e. The end surface 13j is provided with a screw hole 41. An adjustment member 43 provided with a long adjustment hole 42 is fixed to the end surface 13j by inserting a screw 44 into the adjustment hole 42 and threadedly engaging the screw 44 with the screw hole 41. The adjustment hole 42 allows the support shaft 32b of the development roller 32 to move in the axial direction. In a state where the frame bodies 13h of the toner cartridges 13Y, 13M, 13C, and 13K that support the support shafts 32b of the development roller 32 are biased by a plurality of springs 37 in a direction perpendicular to the support shaft 32b of the development roller 32, the photoreceptor support portion 31b of the drum cartridge unit 31 and one of the frame bodies 13h of the toner cartridges 13Y, 13M, 13C, and 13K are abutted against each other, and the photoreceptor support portion 31b and the other frame body 13h are abutted against each other through the adjustment member 43.

When the adjustment member 43 is fixed to the frame body 13h, an inclined surface 43a that is lowered as approaching the developing portion 32a is provided on a surface of the adjustment member 43 opposite from a surface that is in contact with the end surface 13j of the frame body 13h at a location closer to the developing portion 32a than the adjustment hole 42. When the inclined surface 43a is viewed edge-on, a taper angle θ5 formed between the end surface 13j of the frame body 13h and an outline formed by the inclined surface 43a is an acute angle (0<θ5<90°). The taper angle θ5 is the same as the taper angle θ3 of the end surface 31e of the photoreceptor support portion 31b.

The adjusting method of the inter-surface distance Ds between the photosensitive drum 11 and the development roller 32 in this embodiment is different from adjustment performed by moving the roller members 36, 36z in the first and second embodiments. The adjustment is performed by moving the adjustment member 43 in the same direction as the axial direction of the support shaft 32b of the development roller 32.

More specifically, if the adjustment member 43 is moved toward the development roller 32, the inter-surface distance Ds on the side of the photoreceptor support portion 31b that abuts against the adjustment member 43 is increased. The photosensitive drum 11 is adjusted in the direction of the support shaft 11e such that the frame body 13f and the photoreceptor support portion 31b that is in contact with the frame body 13f are aligned with each other and the adjustment member 43 and the photoreceptor support portion 31b that is in contact with the adjustment member 43 are aligned with each other. As a result, the development roller 32 moves in a direction separating away from the photosensitive drum 11, and the inter-surface distance Ds becomes long.

On the contrary, if the adjustment member 43 is moved in a direction separating away from the development roller 32, the development roller 32 moves toward the photosensitive drum 11. As a result, the inter-surface distance Ds becomes short.

Here, θ3 and θ4 are the same, and the inclined surface of the adjustment member 43 and the end surface 31e, as well as the end surface 31d and the end surface 13g form abutment portions, respectively. A force in a direction in which surfaces in the abutment portion are deviated from each other is generated by the biasing force of the spring 37. However, the inclined surface of the adjustment member 43, the end surface 31e, the end surface 31d and the end surface 13g are formed with the inclined surfaces so that the forces in the deviation directions generated in the abutment portions are canceled when the photosensitive drum 11 and the development roller 32 become parallel to each other. With this configuration, it is possible to easily maintain the parallel states of the photosensitive drum 11 and the development roller 32.

After the inter-surface distance Ds between the photosensitive drum 11 and the development roller 32 is adjusted, the screw 44 inserted into the adjustment hole 42 is fastened into the screw hole 41, and the adjustment member 43 is fixed to the frame bodies 13h of the toner cartridges 13Y, 13M, 13C, and 13K.

With the above procedure, it is possible to easily and precisely adjust the inter-surface distance Ds between the photoreceptor 11 and the development roller 32 without relying on the accuracy of the photoreceptor 11 and the development roller 32 and accuracy of parts interposed therebetween. Even after the development roller 32 is once attached to the photoreceptor 11, the inter-surface distance Ds can be adjusted by moving the adjustment member 43 having the inclined surface 43a. That is, even if the adjustment member 43 is used over the long term and it is deviated and the inter-surface distance Ds is varied, the inter-surface distance Ds can be corrected by moving the adjustment member 43.

In the above embodiment, the photoreceptor support portion 31b can move in the axial direction of the support shaft 11e of the photosensitive drum 11, but the drum cartridge unit 31 can rock in the axial direction of the support shaft 11e with respect to the rack on the side of the body where the drum cartridge unit 31 is attached. The rack itself to which the drum cartridge unit 31 is attached may rock in the axial direction of the support shaft 11e with respect to a casing of the image forming apparatus 10.

The present invention is not limited to the embodiments, and the invention can be modified variously. For example, both the roller members 36 may be moved by one operation by means of a structure in which displacement directions of the roller members 36 are opposite from each other and they can be moved by the same displacement amounts and fixed. The development roller 32 may be biased against the photosensitive drum 11 by biasing the entire toner cartridge unit 13.

The taper angle θ may be 45° or less, but if the angle θ becomes greater, fine adjustment becomes difficult. If the angle θ is small on the other hand, a force applied to the roller member 36 becomes small, the roller member 36 is not stably fixed and as a result, it becomes difficult to maintain the inter-surface distance Ds constant and thus, it is preferable that the taper angle is about 5 to 30°.

The image forming apparatus of the present invention includes: a photoreceptor having a first support shaft supported in a first frame body, a photosensitive portion supported by the first support shaft, and a tapered portion having first tapered surfaces on both sides of the photosensitive portion; a development roller opposed to the photoreceptor and having a second support shaft rotatably supported by a second frame body, the development roller being movable in a direction perpendicular to the second support shaft so as to approach and separate from the photoreceptor; roller members disposed on both sides of the development roller coaxially with the second support shaft, the roller member being movable in an axial direction of the second support shaft and including a second tapered surface which abuts against the first tapered surface; a moving member allowing the roller member to move on the second support shaft; and a biasing member biasing the development roller toward the photoreceptor.

According to this configuration, the photoreceptor is supported by the first frame body. The development roller is rotatably supported by the second frame body, and the development roller is opposed to the photoreceptor in a state where the development roller is biased by the biasing member that biases the development roller toward the photoreceptor. By this biasing force, the tapered portion having the first tapered surfaces on both ends of the photosensitive portion of the photoreceptor, and the roller member having a second tapered surfaces provided on both sides of the development roller in to which the second support shaft is inserted and which can move on the second support shaft abut against each other, and inter-surface distance between the photoreceptor and the development roller is maintained constant. By moving the roller member on the second support shaft using the moving member, the inter-surface distance between the photoreceptor and the development roller can be changed in accordance with a moving amount of the roller member on the second support shaft and the taper angle. With this, it is possible to easily and precisely adjust the inter-surface distance between the photoreceptor and the development roller.

It is preferable that the moving member is a bearing that includes an inner peripheral surface that supports the second support shaft, and an outer peripheral surface having a second screw portion that is threadedly engaged with a first screw portion provided in the second frame body. With this configuration, if the development roller is driven, the second tapered surface of the roller member that is coaxially inserted into the second support shaft that is biased toward the photoreceptor abuts against the first tapered surface of the tapered portion of the photoreceptor and with this, a force is applied to the roller member outward of the development roller on the second support shaft. As a result, the roller member moves on the second support shaft and abuts against the bearing. If the bearing is moved forward and backward by the second screw portion with respect to the first screw portion of the second frame body, the roller member also moves forward and backward in a state where the roller member is in abutment with the bearing. Since the second tapered surface of the roller member and the first tapered surface of the tapered portion abut against each other, a distance between the first support shaft and the second support shaft is increased or reduced in accordance with a forward/backward moving amount of the bearing caused by the second screw portion. As a result, it is possible to easily and precisely adjust the inter-surface distance between the photoreceptor and the development roller.

It is preferable that the moving member is the roller member itself provided at its inner peripheral surface with a fourth screw portion that is threadedly engaged with a third screw portion provided on the second support shaft. According to this configuration, it is possible to easily and precisely adjust the inter-surface distance between the photoreceptor and the development roller by the simple structure having the roller member and the second support shaft only.

It is preferable that the first tapered surfaces are circular conical surfaces that are tapered in an axial direction of the first support shaft toward both end surface from the photosensitive portion, and a ridgeline of the second tapered surface abuts against a ridgeline of the first tapered surface.

Another image forming apparatus according to the invention includes: a photoreceptor having a first supporting shaft supported by a first frame body, the photoreceptor being movable in a direction of the first support shaft; a development roller opposed to the photoreceptor and having a second support shaft rotatably supported in a second frame body, the development roller being movable in a direction perpendicular to the second support shaft so as to approach and separate from the photoreceptor; a biasing member biasing the development roller toward the photoreceptor; and an adjustment member movably mounted on any one of the first frame body and the second frame body such that the adjustment member is positioned between the first frame body and the second frame body, a portion of the adjustment member that abuts the other of the first frame body and the second frame body being an inclined surface with respect to a moving direction.

According to this configuration, the adjustment member is positioned between the first frame body that supports the photoreceptor and the second frame body that supports the development roller, and the adjustment member can move. Since the adjustment member includes the inclined surface with respect to the moving direction, if the adjustment member is moved in a state where it is positioned between the first frame body and the second frame body, a distance between the first frame body and the second frame body can be changed. With this, it is possible to easily and precisely adjust the inter-surface distance between the photoreceptor and the development roller.

It is preferable that the first frame body and the second frame body have inclined end surfaces that abut each other and are inclined with respect to a biasing direction of the biasing member, the inclined surface of the adjustment member and the plurality of end surfaces form a plurality sets of abutment portions when biased by the biasing member, and the inclined surface of the adjustment member and the plurality of end surfaces include surfaces that incline in a direction in which forces in deviation directions generated in the abutment portions are canceled by a biasing force of the biasing member.

According to the invention, it is possible to easily and precisely adjust the inter-surface distance Ds between the photoreceptor and the development roller without relying on the accuracy of the photoreceptor and the development roller and accuracy of parts interposed therebetween. Even after the development roller is once attached to the photoreceptor, the inter-surface distance Ds can be adjusted by moving the roller member having the tapered surface or the adjustment member. That is, even if the roller member is used over the long term and it is worn or deviated and the inter-surface distance Ds is varied, the inter-surface distance Ds can be corrected by moving the roller member.

1. An image forming apparatus, comprising:
a photoreceptor having a first support shaft supported in a first frame body, a photosensitive portion supported by the first support shaft, and a tapered portion having first tapered surfaces on both sides of the photosensitive portion;
a development roller opposed to the photoreceptor and having a second support shaft rotatably supported by a second frame body, the development roller being movable in a direction perpendicular to the second support shaft so as to approach and separate from the photoreceptor;
roller members disposed on both sides of the development roller coaxially with the second support shaft, the roller member being movable in an axial direction of the second support shaft and including a second tapered surface which abuts against the first tapered surface;
a moving member allowing the roller member to move on the second support shaft; and
a biasing member biasing the development roller toward the photoreceptor.

2. The image forming apparatus according to claim 1, wherein the moving member is a bearing that includes
an inner peripheral surface that supports the second support shaft, and
an outer peripheral surface having a second screw portion that is threadedly engaged with a first screw portion provided in the second frame body.

3. The image forming apparatus according to claim 1, wherein the moving member is the roller member itself provided at its inner peripheral surface with a fourth screw portion that is threadedly engaged with a third screw portion provided on the second support shaft.

4. The image forming apparatus according to claim 1, wherein the first tapered surfaces are circular conical surfaces that are tapered in an axial direction of the first support shaft toward both end surface from the photosensitive portion, and a ridgeline of the second tapered surface abuts against a ridgeline of the first tapered surface.

5. An image forming apparatus, comprising:
a photoreceptor having a first supporting shaft supported by a first frame body, the photoreceptor being movable in a direction of the first support shaft;
a development roller opposed to the photoreceptor and having a second support shaft rotatably supported in a second frame body, the development roller being movable in a direction perpendicular to the second support shaft so as to approach and separate from the photoreceptor;
a biasing member biasing the development roller toward the photoreceptor; and
an adjustment member movably mounted on any one of the first frame body and the second frame body such that the adjustment member is positioned between the first frame body and the second frame body, a portion of the adjustment member that abuts the other of the first frame body and the second frame body being an inclined surface with respect to a moving direction.

6. The image forming apparatus according to claim 5, wherein the first frame body and the second frame body have inclined end surfaces that abut each other and are inclined with respect to a biasing direction of the biasing member,
the inclined surface of the adjustment member and the plurality of end surfaces form a plurality sets of abutment portions when biased by the biasing member, and the inclined surface of the adjustment member and the plurality of end surfaces include surfaces that incline in a direction in which forces in deviation directions generated in the abutment portions are canceled by a biasing force of the biasing member.
